(19) United States
(12) Patent Application Publication
(10) Pub. No.: US 2025/0209125 A1
(43) Pub. Date: Jun. 26, 2025

(54) USER PREFERENCES BASED ON ENVIRONMENTAL CONTEXT

(71) Applicant: Motorola Mobility LLC, Chicago, IL (US)

(72) Inventors: Krishnan Raghavan, Bangalore (IN); Vignesh Karthik Mohan, Bangalore (IN); Nakul Patel, Bangalore (IN)

(73) Assignee: Motorola Mobility LLC, Chicago, IL (US)

(21) Appl. No.: 18/394,316

(22) Filed: Dec. 22, 2023

(51) Int. Cl. G06F 16/9535; G06F 16/9537

(52) U.S. Cl. CPC G06F 16/9535; G06F 16/9537

(57) ABSTRACT

In aspects of user preferences based on environmental context, a mobile device implements a context suitability manager that obtains media content related to a user. The context suitability manager determines an environmental context based on the media content related to the user. The context suitability manager can determine one or more user preferences associated with activity recommendations for the user given the environmental context derived from the media content related to the user. For example, the one or more user preferences may be based on user participation in an activity indicated by the media content, and/or based on visual content depicted in the media content that is related to the user.

### BACKGROUND

Weather forecast applications on mobile devices provide users with detailed information about current and future weather conditions. The weather forecast applications typically offer a range of features to help users prepare for changing weather patterns by providing real-time information about temperature, humidity, wind speed and direction, as well as visibility and atmospheric pressure at the user's current location or any location of interest. Users can access detailed forecasts for the next few hours or days, including predictions for temperature changes, precipitation, and cloud cover. Some weather forecast applications provide hourly forecasts for the upcoming 24 hours, while other weather forecast applications offer daily forecasts for the next week. Weather forecast applications often issue notifications and alerts for severe weather conditions, such as thunderstorms, hurricanes, tornadoes, blizzards, or other extreme weather events. These alerts help users stay informed and take necessary precautions to ensure their safety. Some weather forecast applications include additional features such as sunrise and sunset times, UV index, air quality index, pollen count, and weather-related news and articles. However, the weather forecast applications fail to provide helpful information involving user preferences in some situations, resulting in technological shortcomings and user frustration.

### BRIEF DESCRIPTION OF THE DRAWINGS

Implementations of the techniques for personalized weather insight information and user preferences based on environmental context are described with reference to the following Figures. The same numbers may be used throughout to reference like features and components shown in the Figures.

FIG. 1 illustrates an example system for personalized weather insight information in accordance with one or more implementations as described herein.

FIG. 2 further illustrates an example of personalized weather insight information, including a user preference generator for user preferences based on environmental context, in accordance with one or more implementations as described herein.

FIGS. 3A-3C illustrate an example of personalized weather insight information implemented in an activity planning application in accordance with one or more implementations as described herein.

FIG. 4 illustrates an example of personalized weather insight information in response to multiple user inputs in accordance with one or more implementations as described herein.

FIG. 5 illustrates an example of personalized weather insight information displayed on a weather preference map in accordance with one or more implementations as described herein.

FIG. 6 illustrates an example of user preferences based on environmental context responsive to a weather preference prompt in accordance with one or more implementations as described herein.

FIG. 7 illustrates an example of personalized weather insight information, including collecting user feedback to update the user preference related to the weather condition in accordance with one or more implementations as described herein.

FIGS. 8-10 illustrate example methods for personalized weather insight information in accordance with one or more implementations of the techniques described herein.

FIGS. 11 and 12 illustrate example methods for user preferences based on environmental context in accordance with one or more implementations of the techniques described herein.

FIG. 13 illustrates various components of an example device that may be used to implement the techniques for personalized weather insight information and/or for user preferences based on environmental context as described herein.

### DETAILED DESCRIPTION

Implementations of the techniques for personalized weather insight information, as well as for user preferences based on environmental context, may be implemented as described herein. A mobile device, such as any type of a wireless device, media device, mobile phone, flip phone, client device, tablet, computing, communication, entertainment, gaming, media playback, and/or any other type of computing, consumer, and/or electronic device, or a system of any combination of such devices, may be configured to perform techniques for generating the personalized weather insight information and/or determining the user preferences based on environmental context, as described herein. In one or more implementations, a mobile device includes a context suitability manager, which can be used to implement aspects of the techniques described herein.

Weather is a major factor in daily life, as many activities are dependent on weather. For instance, sailing requires windy weather, while other activities such as golf are best performed on days without strong wind. Although some activities can be performed in any weather, certain conditions are optimal for an enjoyable time. Swimming in a lake is more enjoyable in warm weather, but running a marathon is more enjoyable in cooler weather. Personal weather preferences that vary from person to person are also a factor in planning activities. For instance, one person may enjoy going for walks in the snow, while another person may hate the snow. For these reasons, planning a successful event involves evaluating personal weather preferences for a particular activity.

Some conventional technologies exist that allow users to manually research weather for planning an activity. For example, conventional weather forecast applications include weather information related to temperature, humidity, wind speed and direction, as well as visibility and atmospheric pressure at the user's current location or other location of interest. Users can access detailed forecasts for the next few hours or days, including predictions for temperature changes, precipitation, and cloud cover. The conventional weather forecast applications provide hourly forecasts for an upcoming 24 hour period and offer daily forecasts for the next week. Many conventional weather forecast applications include interactive weather maps that allow users to view radar, satellite, and other weather-related data. Users can also add multiple locations to their weather app to monitor the weather in different places, including a user's current location, the user's favorite vacation spot, or a city the user plans to visit in the future.

However, planning activities using the conventional weather forecast applications is cumbersome for a user because a conventional weather forecast application does not factor the user's preferences related to a weather condition into the forecast. For example, the user plans on going for a hike today, so the user checks a conventional weather forecast application, which says the temperature will be 65° F. Because the user finds this temperature agreeable, the user begins the hike. However, the user has trouble seeing the hiking trail because the weather is also foggy. Foggy weather is not a weather condition the user generally checks for in the forecast, so the user didn't think to look. However, the user remembers a previous hike through the fog that the user did not enjoy and abandons the hike today to avoid repeating the experience.

Conventional weather forecast applications are also not easily adaptable to scheduling events that will include participation from multiple attendees. For example, the user may manually check weather on the conventional weather forecast application and decide whether the forecast shows weather the user personally finds enjoyable, but the user does not have access to weather preferences for other attendees. Therefore, the user risks planning an event that not everybody enjoys due to the weather conditions during the event.

The concepts and technologies discussed herein generate personalized weather insight information to solve the problems associated with using conventional weather forecast applications. In aspects of the described techniques, a context suitability manager receives an input including a user preference related to a weather condition. For example, the user preference related to the weather condition specifies the user's favorability or unfavorability of the weather condition. In some example implementations, the user preference related to the weather condition is determined based on user input, media content associated with the user the media content depicts the weather condition, or activity data related to the user and the weather condition. The context suitability manager then receives a weather forecast indicating the weather condition.

Based on the user preference related to the weather condition, the context suitability manager generates personalized weather insight information related to the weather forecast and outputs the personalized weather insight information for display on a display device. In some example implementations, the context suitability manager also receives an indication of an activity that the user is planning. The context suitability manager can then generate the personalized weather insight information related to the weather forecast, as well as based on the user preference related to the weather condition for performing the activity. Continuing the example above, the user is provided personalized weather insight information recommending the user not hike today because the weather condition is foggy and the user did not enjoy hiking in the fog in the past, according to information collected by the context suitability manager.

The personalized weather insight information can be determined or generated in this manner to solve the problems associated with using conventional weather forecast applications by leveraging the user preference(s) related to a weather condition to generate the personalized weather insight information. For example, the personalized weather insight information indicates whether the user will enjoy the weather condition of a particular location and time based on the user preferences for performing the activity. This eliminates the need for the user to manually research weather forecasts and decide whether the weather condition is suitable for the activity.

In some example implementations, the personalized weather insight information is based on a group context that considers the user preference related to the weather condition and at least one additional user preference related to the weather condition, such as a user preference from another person in the group context. For example, the personalized weather insight information provides an indication of which attendees to a planned event will not enjoy the weather condition, or provide alternative locations or times for the event that have a weather condition that all attendees will enjoy based on user preferences related to the weather condition for each attendee. This functionality is not possible using conventional weather forecast applications, which do not have access to user preferences related to weather conditions.

Additionally, the concepts and technologies discussed herein can be implemented to determine user preferences based on an environmental context to solve the problems associated with using conventional activity planning applications that do not consider a user's preferences related to environmental context. For example, conventional calendar applications merely provide a forum for organizing events and inviting attendees. The conventional calendar applications, however, fail to take into account preferences for environmental factors, such as the weather, light levels, noise levels, who will be in attendance, sunshine or lack thereof, the time of day or night, the type of activity itself, or any other aspect of an outdoor or indoor environment. This may result in a user planning an activity that does not agree with the user's or other attendees' preferences for environmental context.

In aspects of the described techniques for user preferences based on environmental context, a context suitability manager obtains media content related to a user. The media content related to the user may include a photo, a video, a calendar event, a recorded activity, a social media post, or any other type of media from any of various sources. The context suitability manager determines an environmental context based on the media content related to the user. In implementations, an environmental context can be a depicted environmental condition that is depicted and detectable in the media content related to the user, such as a weather condition, light levels, noise levels, who will be in attendance, sunshine or lack thereof, the time of day or night, the type of activity itself, or any other aspect of an outdoor or indoor environment. In other examples, the environmental context may include any aspect of a user's environment, such as hotel room configuration, airplane seat location, or indoor room temperature.

As used herein to describe user preferences based on environmental context, the term “environmental context” is representative of any number of environmental context (e.g., one context, or multiple context) that may be considered, such as for activity recommendation. The environmental context (e.g., one context, or multiple context) can be identified using any image recognition model trained to identify instances of the different environment context in digital images or any type of media content. The context suitability manager can then determine one or more user preferences associated with an activity recommendation, or multiple activities, for the user given the environmental context derived from the media content related to the user. For example, the context suitability manager receives a photo of a user jogging on a sunny beach, where the photo (e.g., a digital image) is media content related to the user. The context suitability manager determines an environmental context, including weather conditions, such as an amount of sunshine and an estimated temperature based on lighting in the photo. The context suitability manager can then determine a user preference associated with an activity recommendation, including that the user depicted in the photo enjoys running on the beach in the sunshine at the estimated temperature.

The user preferences associated with activity recommendations for the user can then be saved and utilized by any number of applications to account for user preferences related to activity planning, including personalized weather insight information that is determined or generated, as discussed above. For example, the user preferences associated with the activity of running are used when scheduling a run while on vacation based on any number of the environmental context. This allows users to leverage user preferences associated with activity recommendations to plan activities for one or more people, which is not possible using conventional activity planning applications.

While features and concepts of the described techniques for personalized weather insight information and user preferences based on environmental context are implemented in any number of different devices, systems, environments, and/or configurations, implementations of the techniques for personalized weather insight information and user preferences based on environmental context are described in the context of the following example devices, systems, and methods.

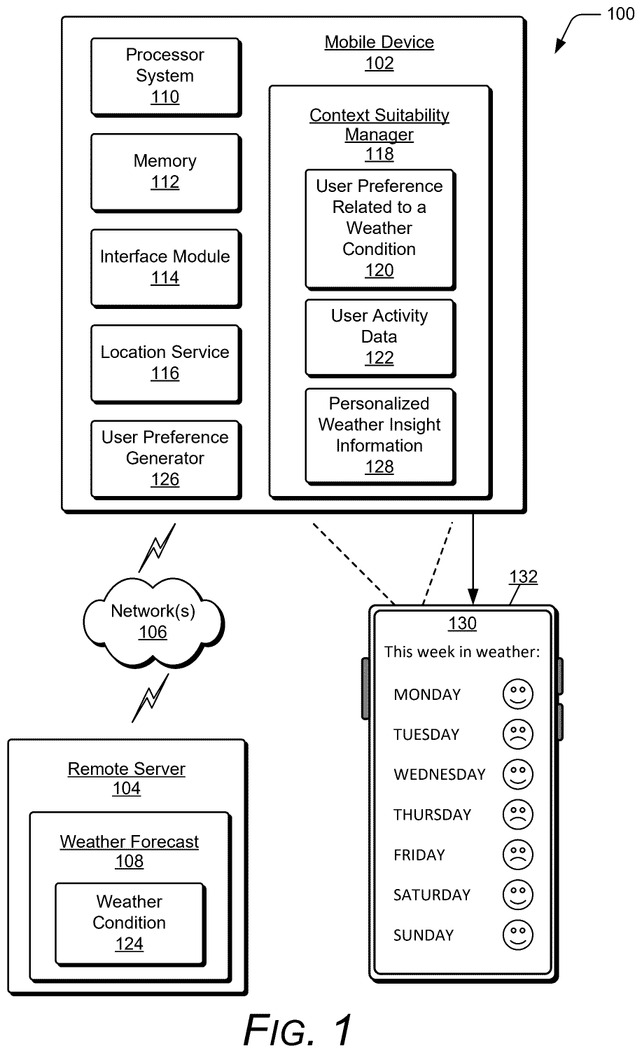

FIG. 1 illustrates an example system 100 for personalized weather insight information, which can be determined or generated as described herein. The system 100 includes a mobile device 102, a remote server 104, and a communication network 106. Examples of mobile device include at least one of any type of a wireless device, mobile device, mobile phone, flip phone, client device, companion device, tablet, computing device, communication device, entertainment device, gaming device, media playback device, or any other type of computing, consumer, and/or electronic device. Examples of the remote server 104 can include any type of server device, cloud storage, network system, and/or any other device that can collect, store, and communicate data separate from the mobile device 102. For example, the remote server 104 can be a network system that collects, stores, and/or communicates weather information including a weather forecast 108.

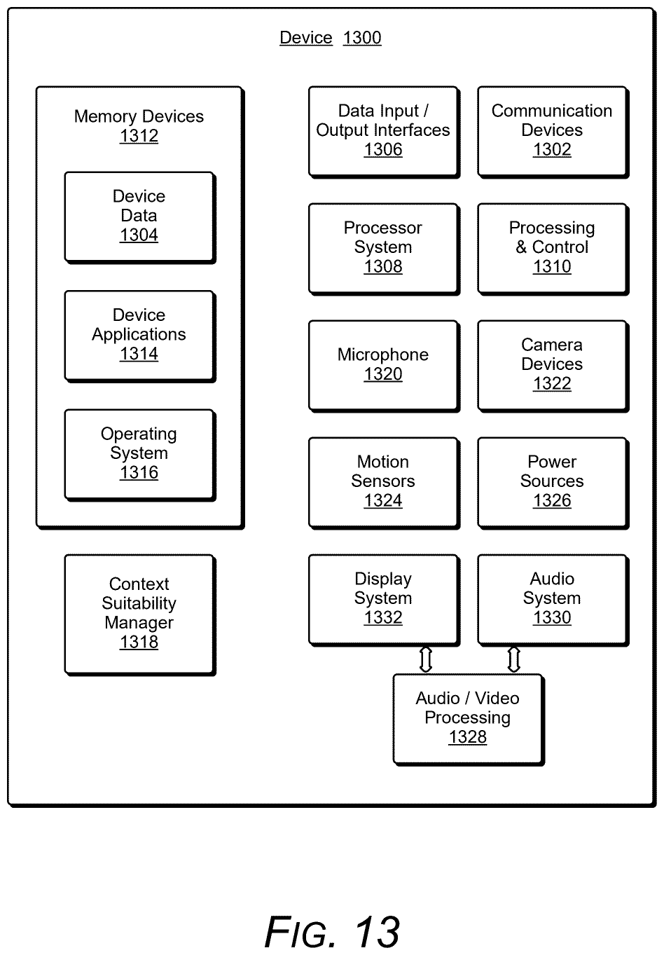

The mobile device 102 can be implemented with various components, such as a processor system 110 and memory 112, as well as any number and combination of different components as further described with reference to the example device shown in FIG. 13. In implementations, the mobile device 102 includes various radios for wireless communication with other devices. For example, the mobile device 102 can include at least one of a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In some implementations, the devices, applications, modules, servers, and/or services described herein communicate via the communication network 106, such as for data communication with the mobile device 102. The communication network 106 includes a wired and/or a wireless network. The communication network 106 can be implemented using any type of network topology and/or communication protocol, and is represented or otherwise implemented as a combination of two or more networks, to include IP-based networks, cellular networks, and/or the Internet. The communication network 106 can also include mobile operator networks that are managed by a mobile network operator and/or other network operators, such as a communication service provider, mobile phone provider, and/or Internet service provider.

The mobile device 102 includes various functionality that enables the device to implement different aspects of personalized weather insight information, which can be determined or generated as described herein. In one or more examples, an interface module 114 represents functionality (e.g., logic and/or hardware) enabling the mobile device 102 to interconnect and interface with other devices and/or networks, such as the communication network 106. For example, the interface module 114 enables wireless and/or wired connectivity of the mobile device 102 and the remote server 104. The interface module 114 can include at least one of a WiFi radio, a cellular radio, a global positioning satellite (GPS) radio, or any available type of device communication interface to interconnect and interface with any devices and/or networks separate from the mobile device 102. The mobile device 102 can also be implemented with a location service 116 as a functionality (e.g., logic and/or hardware) enabling the mobile device to determine a device location in which the mobile device is physically located. For example, the location service 116 can include at least one of a WiFi radio, a cellular radio, a global positioning satellite (GPS) radio, or any available type of device communication interface to determine the device location of the mobile device 102 to receive the weather forecast 108 corresponding to the device location from the remote server 104 via the communication network 106.

The mobile device 102 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102.

In the example system 100 for personalized weather insight information, the mobile device 102 implements a context suitability manager 118 (e.g., as a device application). As shown in this example, the context suitability manager 118 represents functionality (e.g., logic, software, and/or hardware) enabling aspects of the described techniques for personalized weather insight information. The context suitability manager 118 can be implemented as computer instructions stored on computer-readable storage media and can be executed by the processor system 110 of the mobile device 102. Alternatively, or in addition, the context suitability manager 118 can be implemented at least partially in hardware of the device.

In one or more implementations, the context suitability manager 118 includes independent processing, memory, and/or logic components functioning as a computing and/or electronic device integrated with the mobile device 102. Alternatively, or in addition, the context suitability manager 118 can be implemented in software, in hardware, or as a combination of software and hardware components. In this example, the context suitability manager 118 is implemented as a software application or module, such as executable software instructions (e.g., computer-executable instructions) that are executable with the processor system 110 of the mobile device 102 to implement the techniques and features described herein. As a software application or module, the context suitability manager 118 can be stored on computer-readable storage memory (e.g., memory of a device), or in any other suitable memory device or electronic data storage implemented with the controller. Alternatively or in addition, the context suitability manager 118 is implemented in firmware and/or at least partially in computer hardware. For example, at least part of the context suitability manager 118 is executable by a computer processor, and/or at least part of the content manager is implemented in logic circuitry.

In this example system 100, the context suitability manager 118 receives an input including a user preference related to a weather condition 120. The user preference related to the weather condition 120 indicates the user's temperament, including favorability or unfavorability, toward a particular weather condition. For example, a user enjoys both sun and snow but dislikes rain. In some examples, the user preference related to the weather condition 120 indicates the user's favorability or unfavorability toward performing a specific activity in the particular weather condition. For example, although the user enjoys the snow generally, the user dislikes driving in the snow.

In some implementations of personalized weather insight information, the context suitability manager 118 also receives user activity data 122 to determine the user preference related to the weather condition 120. The user activity data 122 may include calendar event data, location data, internet search history data, images, video, notes, social media posts, or other data involving a user activity. The context suitability manager 118 receives calendar event data indicating that the user changed a prior date for a road trip from a day with recorded snowfall in the user's location to a different date with no recorded snowfall in the user's location. Based on the calendar event data, the context suitability manager 118 determines the user preference related to the weather condition 120, including that the user does not enjoy driving in the snow.

Additionally, the context suitability manager 118 receives a weather forecast 108 indicating a weather condition 124 from the remote server 104 via the communication network 106. The weather condition 124 describes current weather for a geographic location or predicts weather for the geographic location. In this example, the weather forecast 108 is a prediction of expected atmospheric conditions for a specific location or region over a certain period of time, ranging from a few hours to several days in advance. In some examples, the weather forecast 108 is a long-range forecast for a period of time several weeks or months in advance based on historical weather data for the specific location of region. The weather forecast 108 includes information such as temperature, precipitation, wind speed and direction, humidity, atmospheric pressure, and other relevant meteorological variables. For instance, the weather forecast 108 predicts a weather condition 124, including a description that a particular day or time period is sunny, cloudy, rainy, snowy, foggy, windy, stormy, hazy, hot, cold, or other descriptions of weather. Additionally, the weather condition 124 includes a description of a temperature, humidity level, UV index level, air quality index level, pollen count, pressure, visibility, or other descriptions of conditions related to weather.

The context suitability manager 118 includes a user preference generator 126 that generates personalized weather insight information 128 related to the weather forecast 108 and based on the user preference related to the weather condition 120. For example, the personalized weather insight information 128 includes a prediction that the user will like or dislike the weather condition 120 in the weather forecast 108. The context suitability manager 118 then outputs the personalized weather insight information 128 for display in a user interface 130 on a display device 132 of the mobile device 102. As shown in FIG. 1, the user interface 130 depicts the personalized weather insight information 128 output by the context suitability manager 118. Here, the personalized weather insight information 128 is organized into a weekly forecast with visual indications presenting the user's preference for a weather condition for each day of the weather forecast 108. For example, instead of displaying a weather icon depicting the weather condition 124 on Monday, the personalized weather insight information 128 includes a smiling face icon, indicating that the user will enjoy the weather on Monday based on the user preference related to the weather condition 120. Alternatively, on Tuesday, the personalized weather insight information 128 includes a frowning face icon, indicating that the user will not enjoy the weather on Tuesday based on the user preference related to the weather condition 120. In other implementations, any other icon, color, or graphic used or displayed to indicate the user preference related to a particular weather condition.

Presenting (e.g., displaying) the personalized weather insight information 128 in this manner relieves the user of mentally determining whether or not he or she will enjoy weather for a particular forecasted day or time period. For example, the weather condition 124 of the weather forecast 108 may include multiple descriptions of weather, as explained above. A particular day may be sunny and also snowy. Using conventional weather applications, the user may see an icon indicating a sunny forecast and embark on a road trip, only to later learn than the forecast also included snow conditions, which are not ideal for traveling. Generating the personalized weather insight information in this manner avoids this confusion, as the frowning face can be displayed indicating user unfavorability of any weather condition 124 in the weather forecast 108 based on the user preference related to the weather condition 120.

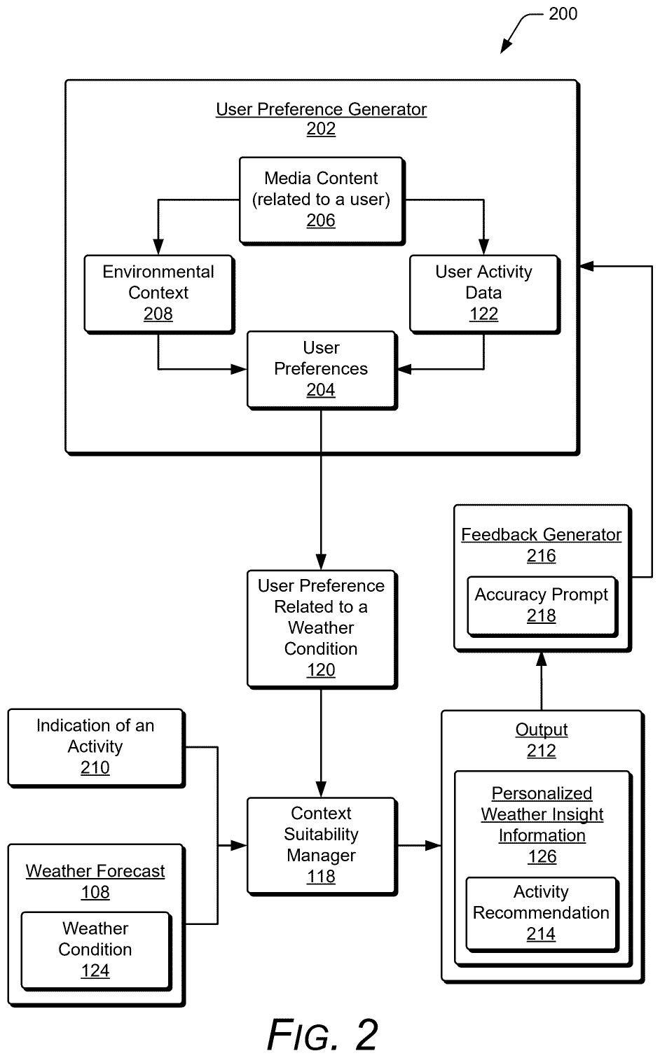

FIG. 2 illustrates an example system 200 for personalized weather insight information, including a user preference generator 202 for user preferences based on environmental context, as described herein. In this example system 200, the user preference generator 202 generates one or more user preferences 204, including a user preference related to a weather condition 120 that is an input (e.g., a data input) to the context suitability manager 118, as shown and described with reference to FIG. 1. In this example system 200, the user preference generator 202 can receive media content 206 that is related to or associated with a user. The media content 206 that is related to the user may be any type of a photo, digital image, a video, a calendar event, a recorded activity, a social media post, or any other type and/or various format of media content. In some example implementations, the media content 206 related to the user is captured, saved, recorded, and/or stored by the user. In other example implementations, the media content 206 related to the user depicts the user or involves an activity in which the user participated.

The user preference generator 202 can determine an environmental context 208 based on the media content 206 that is related to or associated with the user. In some example implementations, an environmental context 208 is a depicted environmental condition, such a weather condition 124, that is depicted in the media content 206 that is related to or associated with the user. In an example, a photo depicts a person standing outside while rain pours down around the person. In this example, the rain is the environmental context 208 depicted in the photo. Other examples of the environmental context 208 can include descriptions of other weather, including sun, clouds, snow, fog, wind, storms, haze, or other types of weather. The environmental context 208 can be identified using any image recognition model trained to identify instances of different weather context and information in images, such as by obtaining a date, the time, and/or a location from the image media data, as well as from environment parameters obtained from the remote server 104. In other example implementations, the environmental context 208 indicates other environmental factors, including estimations of temperature, humidity level, UV index level, air quality index level, or other environmental conditions. For example, a temperature of the environment depicted in the photo can be approximated based on color, light, or other visual properties of the photo. Additionally, other types of environmental context 208, such as the temperature or humidity, can be obtained from historical weather data. The environmental context 208 may also include any aspect of an environment, including indoor or outdoor environments.

In other example implementations, the user preference generator 202 can determine the environmental context 208 based on metadata related to or stored with the media content 206. In this example, metadata refers to data that provides information about other data, such as the media content. The metadata can include context and details about the media content 206 and may include various types of descriptive information associated with a particular file, document, or piece of data that includes one or more portions of the media content 206 that is related to or associated with the user. In this example, the metadata is stored recorded information about the environmental context 208 that existed when the media content 206 was captured or generated. For example, the metadata related to a photo may indicate that the weather was sunny and the temperature was 80° F. (“F”) when the photo was captured.

In some example implementations, the user preference generator 202 can also determine user activity data 122 based on the media content 206 that is related to or associated with the user. The user activity data 122 indicates an activity previously engaged in or performed by the user. For instance, the user activity data 122 is determined based on the media content 206 that is associated with or related to the user and is used to supplement the environmental context 208 by specifying an activity that the user performed in the environmental context 208. The user activity data 122 can be identified using any image recognition model trained to identify performance of an activity depicted in the media content 206. For example, the user preference generator 202 can leverage an image recognition model to identity a person running in a photo and indicate running as the user activity data 122. Similarly, the user preference generator 202 can identify the user activity data 122 in a video, a calendar event, a recorded activity, a social media post and/or in other instances of media content that is related to or associated with the user. For example, a calendar event indicates the user participated in a 5k race on a particular date and therefore also indicates user activity data 122 including running.

Based on the environmental context 208, the user preference generator 202 generates the user preference related to the weather condition 120. For example, the user preference generator 202 can leverage a machine learning model that identifies features in the media content 206 that correspond to a user preference related to the weather condition 120 or to a user preference for the environmental context. Additionally or alternatively, the user preference generator 202 can evaluate and determine from depicted facial expressions, text captions, and/or other factors of the media content 206 to contribute to determining the user preference related to the weather condition 120.

In one example implementation, the user preference generator 202 receives a video of a user skiing in snow. The user preference generator 202 identifies snow as a weather condition 124 that is part of an environmental context 208 of the video, because the snow is prominently featured in the video. Additionally, the user preference generator 202 identifies skiing as the user activity data 122 because the user is skiing in the video. The user preference generator 202 identifies a happy facial expression on the user depicted in the video of the user skiing in the snow and therefore determines the user preference related to the weather condition 120, including a favorability of skiing in the snow.

In an additional example implementation, the user preference generator 202 can identify a caption on a social media post including a photo of the user rock climbing, the caption reading: “too hot today to be climbing.” The user preference generator 202 identifies a high temperature as a weather condition 120 that is part of the environmental context 208 because the post mentions the word “hot.” Recorded weather data specifies that it was 90° F. on the day corresponding to when the photo was posted on social media. Therefore, the user preference generator 202 determines the user preference related to the weather condition 120, including unfavorability of climbing when the temperature is approximately 90° F. In some example implementations, the machine learning model is trained on multiple instances of media content related to or associated with users and corresponding user preferences for environmental contexts.

In some example implementations, the user preference generator 202 can determine the user preference related to the weather condition 120 based on preferred weather settings on other devices connected to the communication network 106. For example, the user preference generator 202 retrieves a saved thermostat setting from the user's heating and air conditioning system, which is connected to the mobile device 102 via the communication network 106. For example, the heating and air conditioning system is set by the user to maintain the user's house at a temperature between 64° F. and 74° F. Therefore, the user preference generator 202 can determine that the user preference related to the weather condition 120 includes a temperature preference of 64° F. to 74° F.

In some example implementations, the user preference generator 202 can determine the user preference related to the weather condition 120 based on biometric data or body vital data collected by sensors connected to the communication network 106. For example, the user preference generator 202 retrieves data collected by sensors measuring heart rate, activity level, sleep pattern, blood oxygen level, body temperature, respiratory level, and/or other biometric or body vital data. For example, the user preference generator 202 retrieves heart date data from the user's smart watch, which is connected to the mobile device 102 via the communication network 106. The heart rate data indicates that the user's heart rate was higher than usual on a particular day that was also hotter than usual, with a temperature of 95° F. The user preference generator 202 determines that the user likely did not enjoy the weather the particular day based on the user's heart rate being higher than usual. Therefore, the user preference generator 202 determines that the user preference related to the weather condition 120 includes a temperature preference below 95° F.

To generate the personalized weather insight information 128, the context suitability manager 118 also receives a weather forecast 108 indicating a weather condition 124. In this example, the weather forecast 108 is a prediction of expected atmospheric conditions for a specific location or region over a certain period of time. The weather forecast 108 includes information such as temperature, precipitation, wind speed and direction, humidity, atmospheric pressure, and other relevant meteorological variables. For instance, the weather forecast 108 predicts a weather condition 124, including a description that a particular day or time period is sunny, cloudy, rainy, snowy, foggy, windy, stormy, hazy, hot, cold, or other descriptions of weather. Additionally, the weather condition 124 includes a description of a temperature, humidity level, UV index level, air quality index level, or other descriptions of conditions related to weather.

The context suitability manager 118 can also receive an indication of an activity 210. The indication of the activity 210 may be a planned activity or event in which the user anticipates participating in or is considering participating. For example, the context suitability manager 118 receives an input indicating that the user is planning a hike. In this example, the indication of the activity 210 specifies hiking. In other example implementations, the indication of the activity 210 is an event.

The context suitability manager 118 then generates the personalized weather insight information 128 related to the weather forecast 108 and based on the user preference related to the weather condition 120, as well as generates an output 212 that includes the personalized weather insight information 128 for display on a display device. For example, the personalized weather insight information 128 includes an activity recommendation 214 for performing an activity specified by the indication of the activity 210 based on the weather condition 120 and the user preference related to the weather condition 120.

In one or more implementations, a feedback generator 216 generates an accuracy prompt 218 for display relative to the personalized weather insight information 128 displayed on the display device. The accuracy prompt 218 collects user input as feedback related to accuracy of the personalized weather insight information 128. For example, the accuracy prompt 218 is displayed on the display device to request that the user confirm as to whether the user agrees with a prediction or recommendation of the personalized weather insight information 128. Results from the accuracy prompt 218 are fed back to the user preference generator 202, which can be used by the user preference generator 202 to re-evaluate the user preferences 204 related to the weather condition 120.

In some example implementations, the user preference generator 202 generates a user preference 204 related to an environmental context other than weather. An environmental context 208 may include any features or attributes of an environment, such as an indoor temperature, indoor humidity, room size, room shape, room layout, furniture placement, as well as colors, textures, and materials of portions of a physical environment.

In an example implementation of an environmental context involving facility equipment for an indoor environment that is unrelated to weather, a user may desire to schedule a meeting in a room that is suitable for the needs of the meeting attendees. For example, the user preference generator 202 receives the media content 206 that is associated with or related to the user, such as a calendar event indicating the user previously changed a location for a meeting for a “Finance Meeting” from Conference Room A to Conference Room B. Based on a database available to the user preference generator 202, the user preference generator 202 identifies that Conference Room A seats 20 people but does not have a particular type of meeting room equipment, such as a projector, a whiteboard, etc., whereas Conference Room B seats 10 people and does have the particular type of meeting room equipment that will be needed to conduct the meeting. Therefore, the environmental context 208 includes the presence of the equipment in a meeting room. Based on the environmental context 208, the user preference generator 202 generates the user preference related to the environmental context. For example, the user preference generator 202 can leverage a machine learning model that identifies features in the media content 206 that corresponds to the user preference related to the environmental context 208.

In this example because the user changed the location for the “Finance Meeting” from Conference Room A to Conference Room B, the user preference generator 202 determines that at least one feature of Conference Room A was not preferable, while the features of Conference Room B were preferable. Because Conference Room B seats fewer people than Conference Room A, the lack of the particular type of meeting room equipment was likely why the user previously changed meeting rooms. Therefore, the user preference generator 202 can determine a user preference for the environmental context specifying that the user prefers meeting rooms with the particular type of equipment for “Finance Meetings.” In additional examples, the user preference generator 202 can determine user preferences 204 for environmental contexts related to airplane seats, restaurant types, restaurant tables, movie theater seats, train seats, rideshare automobile types, and any other environmental context.

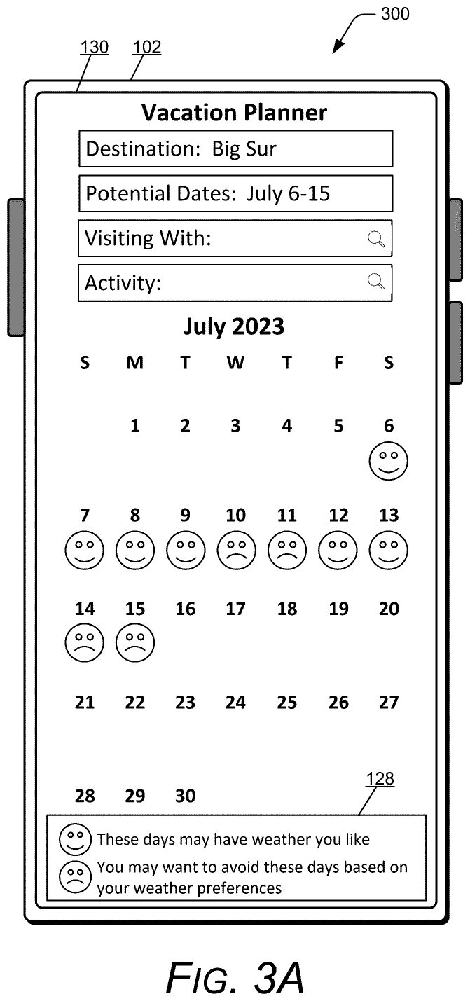

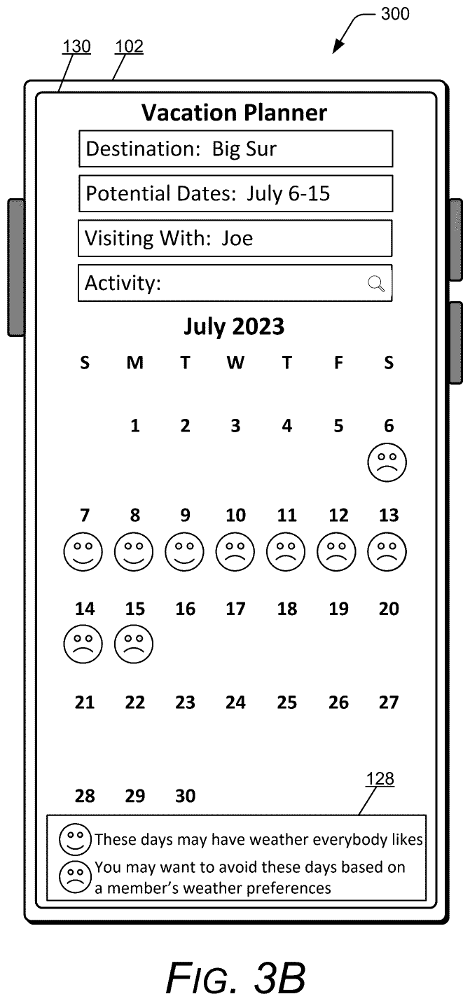

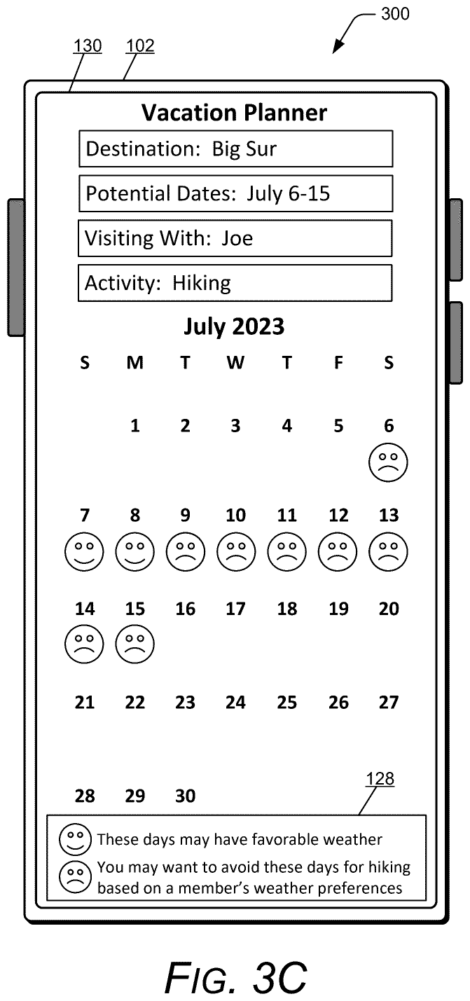

FIG. 3A illustrates example 300 of personalized weather insight information implemented in an activity planning application, as described herein. In this example 300, the context suitability manager 118 generates an output for display in a user interface 130 on a display device of the mobile device 102. The user interface 130 includes an example of the personalized weather insight information 128 in response to a user input. In this example, the context suitability manager 118 is implemented with, incorporated into, implemented with, or accessible by a vacation planning application on the mobile device 102. The vacation planning application includes fields for user input specifying “Destination:” “Potential Dates:” “Visiting With:” and “Activity.” In other implementations, the context suitability manager 118 is incorporated into or accessible by any device application with any number or category of input fields. The context suitability manager 118 receives a Destination input of “Big Sur,” indicating a geographic location the user is planning for a vacation (e.g., an activity or event). Additionally, the context suitability manager 118 in this example receives a Potential Dates input of July 6-15, indicating a date range for the vacation.

Based on just the first two inputs specifying the geographic location of Big Sur and the vacation dates of July 6-15, the context suitability manager 118 can retrieve a weather forecast 108 for geographic location during the specified upcoming vacation dates, where each day will have a projected weather condition 120. In this example and as shown on the user interface 130, July 6 has a weather condition of sunny and 50° F., July 7 has a weather condition of sunny and 60° F., July 8 has a weather condition of sunny and 60° F., July 9 has a weather condition of sunny and 80° F., July 10 has a weather condition of rainy and 60° F., July 11 has a weather condition of rainy and 60° F., July 12 has a weather condition of sunny and 50° F., July 13 has a weather condition of sunny and 50° F., July 14 has a weather condition of rainy and 60° F., and July 15 has a weather condition of rainy and 60° F.

The context suitability manager 118 also receives a user preference related to a weather condition 120 specifying that the user in this example enjoys sunny weather but does not enjoy rainy weather. The user does not have a preference for temperature unless a specific activity is involved. Based on the user preference related to the weather condition 120, the context suitability manager 118 generates personalized weather insight information 128. In this example, because July 10, 11, 14, and 15 have a weather condition 120 of rainy, the personalized weather insight information 128 includes visual indications of frowning faces displayed on the respective dates in the calendar user interface, indicating to the user that those days are to be avoided based on the user's preferred weather for the indicated activity. The other days include visual indications of smiling faces, indicating that those days may have weather to the user's liking.

FIG. 3B illustrates a continuation of the example 300 of personalized weather insight information implemented in the activity planning application, as described herein. In this example 300, the context suitability manager 118 generates an output for display in the user interface 130 on the display device of the mobile device 102. The user interface 130 includes personalized weather insight information 128 in response to an additional user input. Continuing with the example of the context suitability manager 118 incorporated into a vacation planning application, the context suitability manager 118 receives an additional input specifying the user is visiting Big Sur with “Joe.” The additional input indicating the additional visitor is received in conjunction with the Destination input of “Big Sur” and the Potential Dates input of July 6-15, as previously described with respect to FIG. 3A. Further, the context suitability manager 118 retrieves or obtains the weather forecast 108 for Big Sur during the dates of July 6-15, each day having a weather condition 120, as described with reference to FIG. 3A.

In addition to receiving the user preference related to a weather condition 120 specifying that the user in this example enjoys sunny weather but does not enjoy rainy weather, the context suitability manager 118 also receives an additional user preference related to the weather condition. In this example, Joe shares the preference for sunny weather with the user, but Joe additionally does not enjoy weather that is colder than 55° F. Based on the additional user preference related to the weather condition, the context suitability manager 118 updates or adjusts the personalized weather insight information 128. In this example, because July 6, 12, and 13 have temperatures below 55° F., the personalized weather insight information 128 includes visual indications of frowning faces displayed on the respective dates on the calendar user interface, in addition to the visual indications of frowning faces displayed for July 10, 11, 14, and 15 that have a weather condition 120 of rainy, indicating to the user that those days are to be avoided based on both the user's and Joe's preferred weather. The other days include visual indications of smiling faces, indicating that those days may have weather to both the user and Joe's liking.

In some example implementations, the additional user preference related to the weather condition is shared with the context suitability manager 118 by the additional user or is collected by the context suitability manager 118 from a database of information pertaining to multiple users. In one example, the user requests the additional user to send the additional user preference related to the weather condition, which is then input to the context suitability manager 118. In another example, the context suitability manager 118 automatically collects or obtains the additional user preference related to the weather condition was previously collected or determined during previous activity planning.

FIG. 3C illustrates a continuation of the example 300 of personalized weather insight information implemented in the activity planning application, as described herein. In this example 300, the context suitability manager 118 generates an output for display in the user interface 130 on the display device of the mobile device 102. The user interface 130 includes the personalized weather insight information 128 in response to an activity input. Continuing with the example of the context suitability manager 118 incorporated into the vacation planning application, the context suitability manager 118 receives an activity input specifying that the user and Joe will be “Hiking.” The additional input is received in conjunction with the Destination input of “Big Sur,” the Potential Dates input of July 6-15, and the input specifying the user is visiting with “Joe,” as previously described with respect to FIGS. 3A and 3B. Further, the context suitability manager 118 retrieves or obtains the weather forecast 108 for Big Sur during the dates of July 6-15, each day having a weather condition 120, as described with reference to FIG. 3A.

As described above, the context suitability manager 118 receives the user preference related to a weather condition 120 specifying that the user in this example enjoys sunny weather but does not enjoy rainy weather, and an additional user preference related to the weather condition specifying that Joe shares the preference for sunny weather with the user, but Joe additionally does not enjoy weather that is colder than 55° F. Before the activity input was received, the context suitability manager 118 ignored specific user preferences related to the weather condition for a specific activity. However, after receiving the activity input specifying the activity of hiking, the context suitability manager 118 determines whether either the user or Joe has a specific user preference related to the weather condition 124 for hiking. For example, Joe does not enjoy hiking when the temperature is above 75° F., but Joe has no indicated preference related to hiking.

Based on the user's preference related to the weather condition 124 for the activity of hiking, the context suitability manager 118 updates the personalized weather insight information 128. In this example, because July 9 has a temperature above 75° F., the personalized weather insight information 128 includes a visual indication of a frowning face displayed on the date for July 9 on the calendar, in addition to the visual indications of frowning faces displayed for July 10, 11, 14, and 15 that have a weather condition 120 of rainy and the frowning faces for July 6, 12, and 13 that are too cold for Joe's preference, indicating to the user that those days are to be avoided based on both the user's and Joe's preferred weather specific for hiking. The other days include visual indications of smiling faces, indicating that those days may have weather to both the user and Joe for hiking.

In other example implementations, conflicts between the user preference related to the weather condition 120 and additional user preferences related to the weather condition can be resolved using predefined criteria or additional user input. Some example implementations can employ weighted factors assigned to user preferences to resolve conflicts and/or to automatically favor the user preference related to the weather condition 120 over additional user preferences related to the weather. Based on these determinations, the user can quickly discern from the user interface 130 that July 7 and 8 are the only days within the specified date range with weather that both the user and Joe enjoy for hiking. The personalized weather insight information allows the user to avoid manually collecting Joe's preferences for weather and comparing forecast weather conditions to both the user's and Joe's preferences for weather for each potential vacation day.

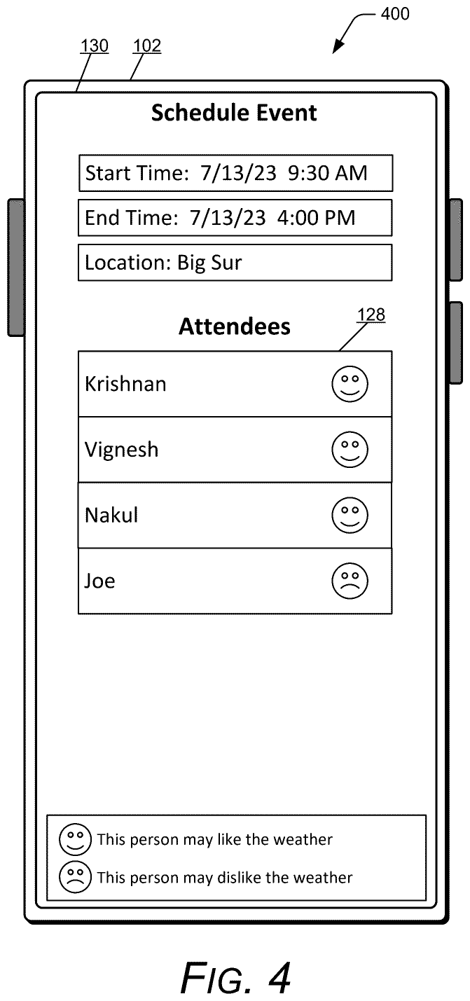

FIG. 4 illustrates example 400 of personalized weather insight information that is determined or generated in response to multiple user inputs, as described herein. In this example 400, the context suitability manager 118 generates an output for display in the user interface 130 on the mobile device 102, and the user interface includes personalized weather insight information 128 displayed in response to the multiple user inputs. In this example, the context suitability manager 118 is implemented with, incorporated into, or accessible by a scheduling application for scheduling an event. The scheduling application includes fields for user input specifying “Start Time,” “End Time,” and “Location.” In other implementations, the context suitability manager 118 is incorporated into, implemented with, or accessible by any device application with any number or category of input fields.

In this example, the context suitability manager 118 receives a start time input of Jul. 13, 2023 at 9:30 AM, indicating when the event will begin, and also receives an end time input of Jul. 13, 2023 at 4:00 PM, indicating when the event will end. The context suitability manager 118 in this example receives a location input of “Big Sur,” indicating where the event will take place. Additionally, the context suitability manager 118 in this example receives a list of attendees, including “Krishnan,” “Vignesh,” “Nakul,” and “Joe.” In some implementations, the attendees may correspond to contacts stored in device memory of the mobile device 102. Based on the inputs specifying the geographic location of Big Sur and the date of July 13, the context suitability manager 118 retrieves or obtains a weather forecast 108 for the geographic location indicating a weather condition 120 projected for July 13. In this example, July 13 has a weather condition of sunny and 52° F.

The context suitability manager 118 also receives a user preference related to a weather condition 120 for each attendee. In this example, Krishnan enjoys sunny weather that is approximately warmer than 52° F., Vignesh enjoys any weather that is warmer than 50° F., Nakul enjoys sunny weather but does not enjoy temperatures hotter than 75° F., and Joe also enjoys sunny weather but prefers temperatures warmer than 65° F. In some example implementations, the user preferences related to a weather condition are manually entered or are shared to a mobile device implementing the context suitability manager 118 from respective mobile devices or storage locations associated with the attendees.

Based on the user preference related to the weather condition 120 for each attendee, the context suitability manager 118 generates the personalized weather insight information 128 for each attendee. In this example, Krishnan, Vignesh, and Nakul will all enjoy the weather condition of sunny and 52° F. The context suitability manager 118 generates personalized weather insight information 128 including visual indications of smiling faces displayed relative to Krishnan, Vignesh, and Nakul's names in the user interface 130, indicating that those users will enjoy the weather at the event location on the specified date. However, because Joe prefers temperatures warmer than 65° F. and Big Sur has a weather condition of 52° F. on the specified date, the context suitability manager 118 generates the personalized weather insight information 128 including a frowning face displayed relative to Joe's name in the user interface 130, indicating that Joe will not enjoy the weather at the event location on the specified date. This can prompt the user to either select different dates, select a different location, or to not invite Joe. The personalized weather insight information generated or determined in this manner allows the user to avoid manually collecting the attendee's preferences for weather and comparing forecast weather conditions for all of the attendee's preferences for the planned event.

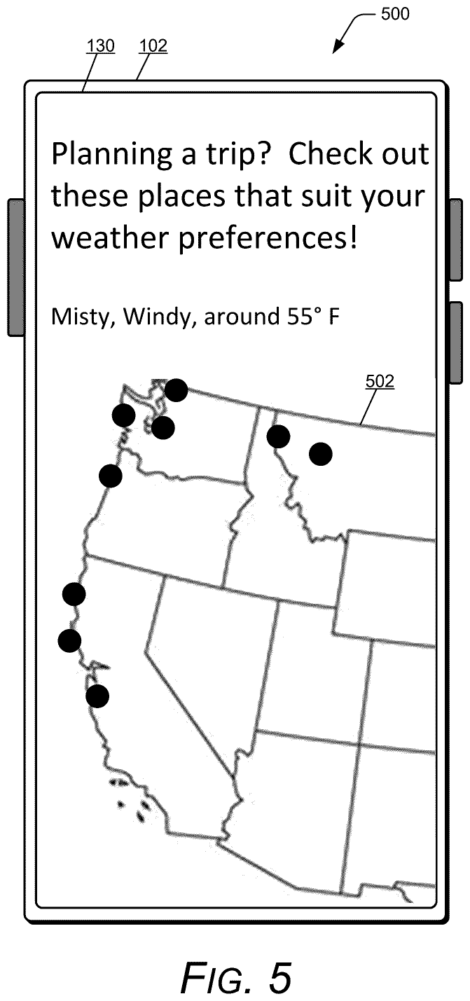

FIG. 5 illustrates example 500 of personalized weather insight information displayed on a weather preference map, as described herein. In this example 500, the context suitability manager 118 generates an output for display in a user interface 130 on a display device of the mobile device 102, and the user interface includes personalized weather insight information 128 displayed on a weather preference map 502. In this example, the context suitability manager 118 is incorporated into, implemented with, or accessible by a trip planning application. The trip planning application determines and suggests destinations based on personalized weather insight information 128. For example, the context suitability manager 118 receives an input including a user preference related to a weather condition 120. In some example implementations, the context suitability manager 118 receives a number of user inputs specifying parameters to narrow aspects of trip planning.

In this example, the user preference related to a weather condition 120 specifies that the user enjoys misty, windy weather with temperatures around 55° F. Based on the user preference related to the weather condition 120, the context suitability manager 118 generates personalized weather insight information 128 displayed on the weather preference map 502 in the user interface 130. For instance, the weather preference map 502 includes dots marking various geographic locations with weather that is approximately misty, windy weather with temperatures around 55° F. The context suitability manager 118 displays the weather preference map 502 in the user interface 130 along with a suggestion to consider traveling to the marked geographic locations. The personalized weather insight information determined or generated in this manner allows the user to avoid manually researching weather conditions in various locations because the context suitability manager 118 automatically generates personalized weather insight information 128 displayed on the weather preference map 502, which communicates potential travel destinations to the user.

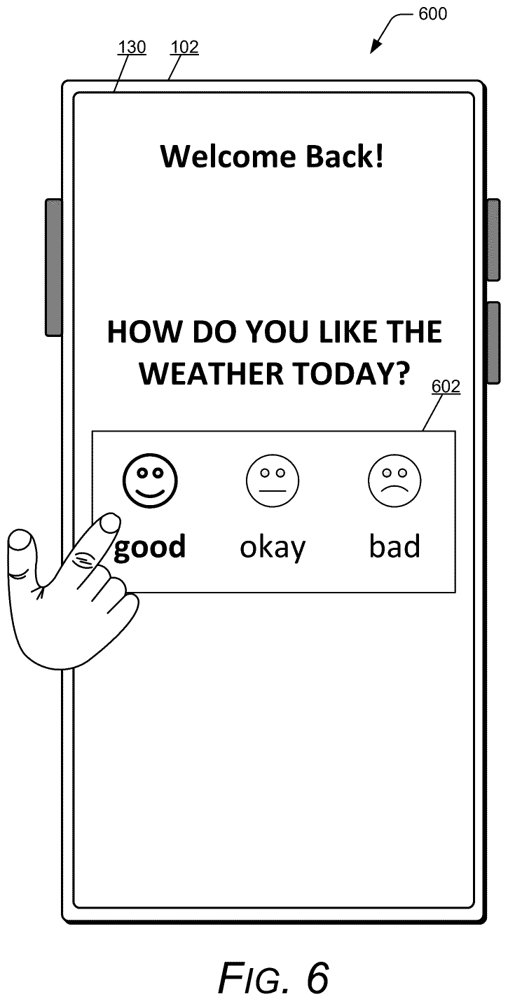

FIG. 6 illustrates example 600 of user preferences based on environmental context, such as the user preferences determined responsive to a weather preference prompt, as described herein. In this example 600, the context suitability manager 118 determines a user preference related to a weather condition 120 based on a user input responsive to a weather preference prompt 602. The context suitability manager 118 can initiate to display a weather preference prompt 602 in the user interface 130 on the mobile device 102 to collect an indication of a user preference related to a weather condition 120. In this example, the weather preference prompt 602 provides a prompt indicating “How do you like the weather today?” and provides user-selectable buttons or controls, such as a button marked “good,” a button marked “okay,” and a button marked “bad.” In this example, the user selects the button marked “good,” and the context suitability manager 118 receives a corresponding input indicating that the user enjoys the weather today. In other example implementations, the weather preference prompt 602 includes any variation of a prompt configured to collect data related to a user preference related to a weather condition 120.

To determine the user preference related to the weather condition 120, the context suitability manager 118 receives or obtains a weather forecast 108 indicating a weather condition 124 from the remote server 104 via the communication network 106. The weather condition 124 includes information such as temperature, precipitation, wind speed and direction, humidity, atmospheric pressure, and/or other relevant meteorological variables. In some example implementations, the weather condition 124 may include a description that the current weather is sunny, cloudy, rainy, snowy, foggy, windy, stormy, hazy, hot, cold, and/or other descriptions of weather. Additionally, the weather condition 124 can include a description of a temperature, humidity level, UV index level, air quality index level, and/or other description of conditions related to the weather.

The context suitability manager 118 can then determine the user preference related to the weather condition 120 based on the user input in response to the weather preference prompt 602 and the weather condition 124. In an example, input collected via the weather preference prompt 602 displayed on the user interface 130 indicates that the user enjoys the current weather, which includes a weather condition 124 of light rain, low humidity, and a temperature around 70° F. In response, the context suitability manager 118 can determine that the user preference related to the weather condition 120 specifies the light rain, low humidity, and a temperature around 70° F. In some example implementations, the user preference related to the weather condition 120 is stored in memory associated with the user for later use by the context suitability manager 118.

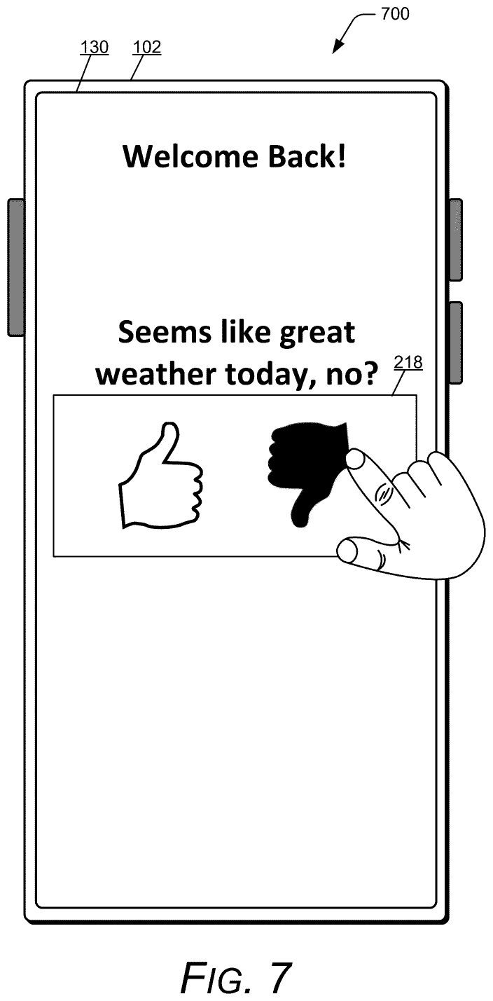

FIG. 7 illustrates example 700 of personalized weather insight information, which can be determined including collecting user feedback to update the user preference related to the weather condition, as described herein. In this example 700, the context suitability manager 118 collects user feedback to update the user preference related to the weather condition 120. In implementations, the context suitability manager 118 can generate the accuracy prompt 218 for display in the user interface 130 of the mobile device 102. The accuracy prompt 218 collects user input related to accuracy of the personalized weather insight information 128. For example, the accuracy prompt 218 is displayed on the display device to request that the user confirm as to whether the user agrees with a prediction or recommendation of the personalized weather insight information 128. Results from the accuracy prompt 218 are fed back to the context suitability manager 118 and can be used by the context suitability manager 118 to update the user preference related to the weather condition 120.

In this example, the context suitability manager 118 predicts that the user is enjoying the current weather based on a weather condition 124 of the current weather corresponding with the user preference related to the weather condition 120. To test this prediction, the context suitability manager 118 can generate an accuracy prompt 218 that includes a prompt indicating “Seems like great weather today, no?” and provides a thumbs-up button for the user to click if the user agrees or a thumbs down button to click if the user does not agree. However, in other example implementations, the accuracy prompt 218 can include any variation of a prompt configured to collect data related to an accuracy of a user preference related to a weather condition 120. In this example, the user clicks the thumbs-down button, and the context suitability manager 118 receives a corresponding input indicating that the user does not agree with the user preference related to the weather condition 120, as generated or determined by the context suitability manager 118. In response, the context suitability manager 118 updates the user preference related to the weather condition 120 to indicate that the user does not enjoy the weather condition 124 or at least a feature of the weather condition 124.

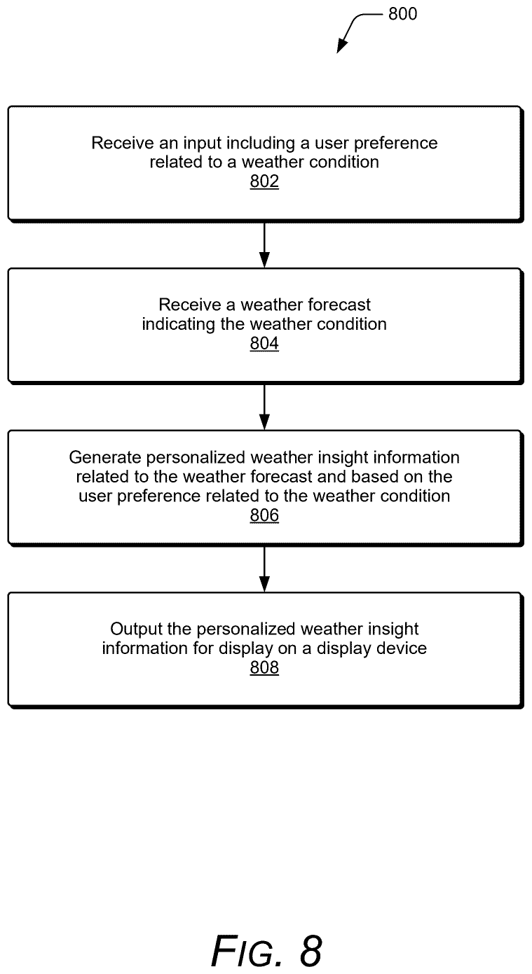

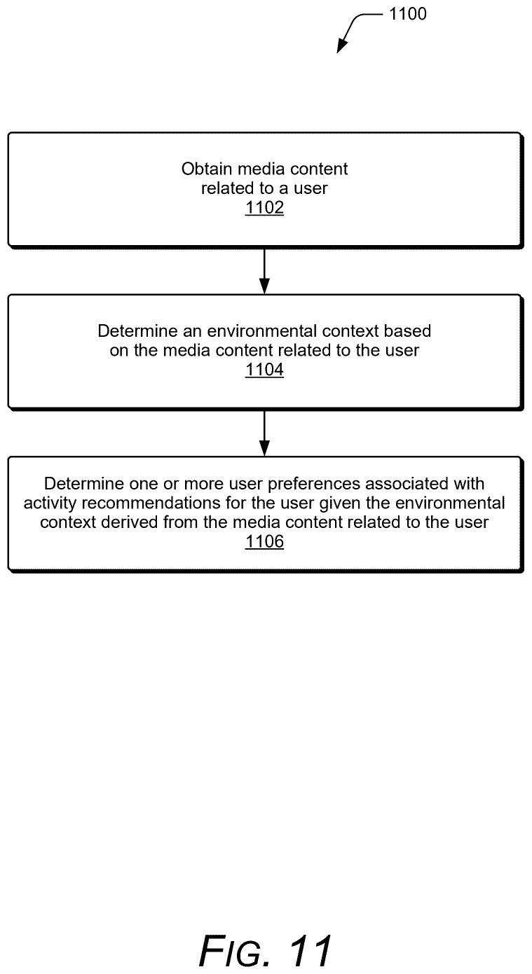

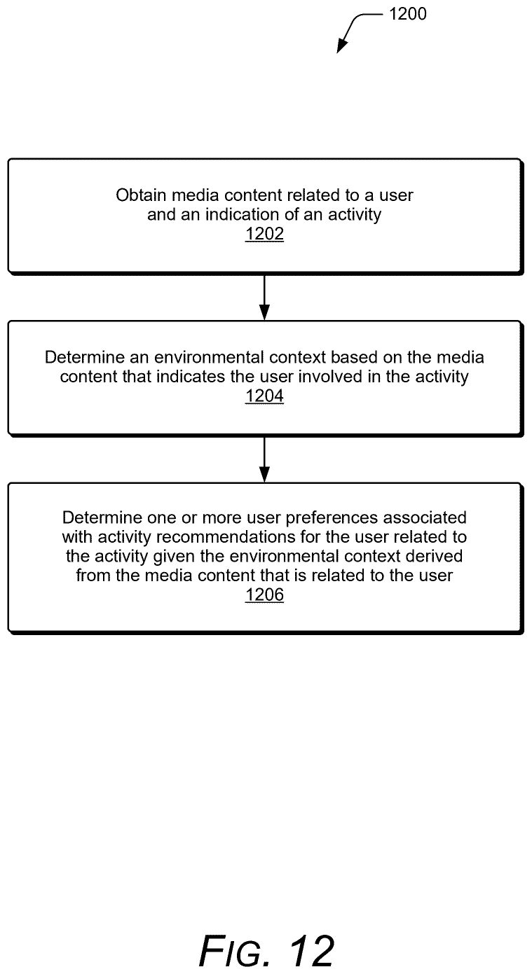

Example methods 800, 900, and 1000 are described with reference to respective FIGS. 8, 9, and 10 in accordance with one or more implementations of personalized weather insight information, as described herein. Example methods 1100 and 1200 are described with reference to respective FIGS. 11 and 12 in accordance with one or more implementations of user preferences based on environmental context, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 8 illustrates example method(s) 800 for personalized weather insight information. The order in which the method is described is not intended to be construed as a limitation, and any number or combination of the described method operations may be performed in any order to perform a method, or an alternate method.

At 802, an input is received including a user preference related to a weather condition. For example, the context suitability manager 118 receives a user preference related to a weather condition 120 based on user activity data 122 related to the weather condition 124. In some implementations, the user preference related to the weather condition 120 is based on user input specifying favorability or unfavorability of the weather condition 124.

At 804, a weather forecast is received indicating the weather condition. For example, the context suitability manager 118 receives the weather forecast 108 indicating the weather condition 124, such as a prediction of expected atmospheric conditions for a specific location or region over a certain period of time.

At 806, personalized weather insight information related to the weather forecast and based on the user preference related to the weather condition is generated. For example, the context suitability manager 118 generates personalized weather insight information 128 that includes a recommendation for an activity given the weather forecast 108. In some implementations, the personalized weather insight information 128 is based on a group context that considers the user preference related to the weather condition 120 and at least one additional user preference related to the weather condition. For example, the personalized weather insight information 128 includes a recommendation for a destination given the weather forecast 108.

At 808, the personalized weather insight information is output for display on a display device. For example, the context suitability manager 118 outputs the personalized weather insight information 128, which includes a visual indication of the user preference related to the weather condition 120. In some implementations, the personalized weather insight information 128 is adjusted based on an additional input including a rating for the weather condition 124. For example, the personalized weather insight information 128 is displayed relative to schedule information and indicates at least one of a date or time to engage in an activity.

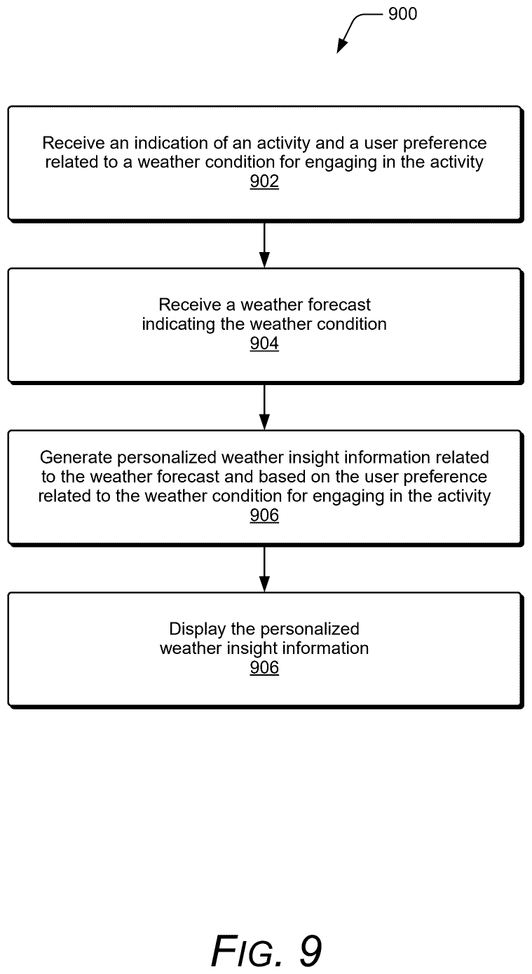

FIG. 9 illustrates example method(s) 900 for personalized weather insight information. The order in which the method is described is not intended to be construed as a limitation, and any number or combination of the described method operations may be performed in any order to perform a method, or an alternate method.

At 902, an indication of an activity and a user preference related to a weather condition for engaging in the activity are received. For example, the context suitability manager 118 receives an indication of an activity 210 and a user preference that is based on user input specifying favorability or unfavorability of the weather condition 124.

At 904, a weather forecast indicating the weather condition is received. For example, the context suitability manager 118 receives a weather forecast 108 that is a prediction of expected atmospheric conditions for a specific location or region over a certain period of time.

At 906, personalized weather insight information related to the weather forecast and based on the user preference related to the weather condition for engaging in the activity is generated. For example, the context suitability manager 118 generates the personalized weather insight information 128 that includes a visual indication of the user preference related to the weather condition 120 for engaging in the activity. In some examples, the context suitability manager 118 generates the personalized weather insight information 128 that is based on a group context that considers the user preference related to the weather condition 120 and at least one additional user preference related to the weather condition. For example, the activity information includes a recommendation for a destination given the weather forecast 108. In some implementations, the context suitability manager 118 adjusts the activity information based on an additional input including a rating for the weather condition 124.

At 908, the personalized weather insight information is displayed. For example, the context suitability manager 118 initiates to display the personalized weather insight information 128 in a user interface, such as on a mobile device. In some examples, the context suitability manager 118 outputs to display the personalized weather insight information 128 relative to schedule information and indicates at least one of a date or time to engage in the activity.

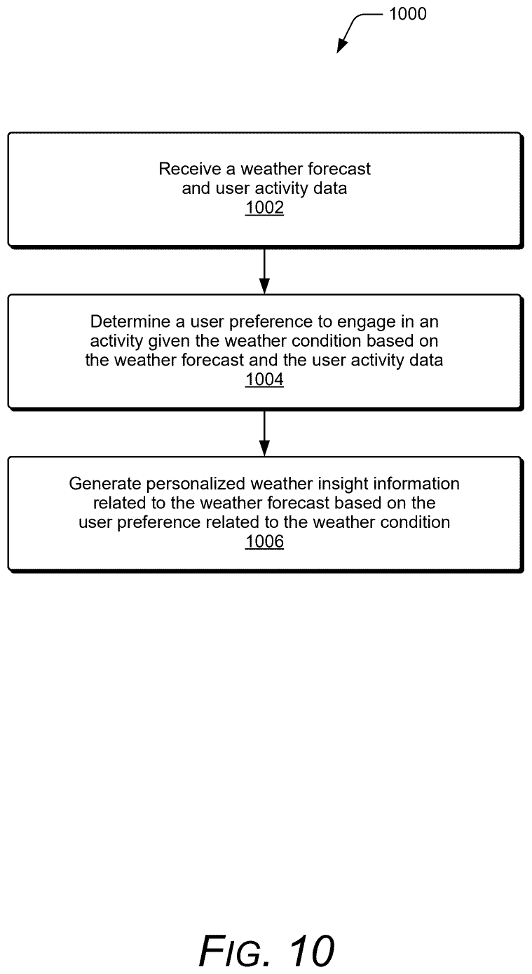

FIG. 10 illustrates example method(s) 1000 for personalized weather insight information. The order in which the method is described is not intended to be construed as a limitation, and any number or combination of the described method operations may be performed in any order to perform a method, or an alternate method.

At 1002 a weather forecast and user activity data are received. For example, the context suitability manager 118 receives a weather forecast 108 and user activity data 122. At 1004 a user preference to engage in an activity given a weather condition based on the weather forecast and the user activity data is determined. For example, the context suitability manager 118 determines a user preference based on user input specifying favorability or unfavorability of a weather condition 124.

At 1006 personalized weather insight information related to the weather forecast based on the user preference related to the weather condition is generated. For example, the context suitability manager 118 generates personalized weather insight information 128 related to the weather forecast 108 based on a group context that considers the user preference related to the weather condition 124 and at least one additional user preference related to the weather condition 124. In some examples, the personalized weather insight information 128 includes a visual indication of the user preference to engage in an activity given the weather condition 124.

FIG. 11 illustrates example method(s) 1100 for user preferences based on environmental context. The order in which the method is described is not intended to be construed as a limitation, and any number or combination of the described method operations may be performed in any order to perform a method, or an alternate method.

At 1102, media content related to a user is obtained. For example, the context suitability manager 118 obtains media content 206 related to a user, and in implementations, the media content can include a photo, a video, a calendar event, a recorded activity, and/or a social media post.

At 1104, an environmental context based on the media content related to the user is determined. For example, the context suitability manager 118 determines an environmental context 208 based on the media content 206 that is related to the user by determining a location, an activity, or a time as determined from the media content. In some examples, the context suitability manager 118 determines an environmental context 208 based on the media content 206 by obtaining weather data corresponding to the location, the activity, or the time as determined from the media content 206 that is related to the user, and determines a weather condition 124 corresponding to the weather data. For example, the one or more user preferences 204 may be based on user participation in an event indicated by the media content 206 that is related to the user, or the one or more user preferences 204 may be based on visual content depicted in the media content 206 that is related to the user.

At 1106, one or more user preferences associated with activity recommendations for the user are determined given the environmental context derived from the media content related to the user. For example, the context suitability manager 118 determines user preferences associated with activity recommendations for the user based on user participation in an event indicated by the media content 206 that is related to the user. In some examples, the one or more user preferences 204 are based on visual content depicted in the media content 206. In some implementations, the one or more user preferences 204 are based on a setting for a device related to the user. In other examples, the one or more user preferences 204 are based on text describing the media content 206.

FIG. 12 illustrates example method(s) 1200 for user preferences based on environmental context. The order in which the method is described is not intended to be construed as a limitation, and any number or combination of the described method operations may be performed in any order to perform a method, or an alternate method.

At 1202, media content related to a user and an indication of an activity is obtained. For example, the context suitability manager 118 obtains the media content 206 that is related to the user, and the media content includes a photo, a video, a calendar event, a recorded activity, and/or a social media post.

At 1204, an environmental context is determined based on the media content that indicates the user involved in the activity. For example, the context suitability manager 118 determines an environmental context 208 based on the media content 206 that is related to the user, and the media content indicates the user involved the activity based on a location, an activity, or a time as determined from the media content. In some examples, the context suitability manager 118 obtains weather data corresponding to the location, the activity, or the time as determined from the media content. For example, the context suitability manager 118 determines a weather condition 124 corresponding to the weather data.

At 1206, one or more user preferences associated with activity recommendations for the user related to the activity are determined given the environmental context derived from the media content that is related to the user. For example, the context suitability manager 118 determines the user preferences 204 associated with activity recommendations for the user related to the activity based on user participation in an event indicated by the media content 206 that is related to the user. In some examples, the context suitability manager 118 determines the user preferences associated with the activity recommendations for the user based on visual content depicted in the media content 206 that is related to the user.

FIG. 13 illustrates various components of an example device 1300, which can implement aspects of the techniques and features for personalized weather insight information, as well as user preferences based on environmental context, as described herein. The example device 1300 may be implemented as any of the devices described with reference to the previous FIGS. 1-12, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102 described with reference to FIGS. 1-12 may be implemented as the example device 1300.

The example device 1300 can include various, different communication devices 1302 that enable wired and/or wireless communication of device data 1304 with other devices. The device data 1304 can include any of the various devices data and content that is generated, processed, determined, received, stored, and/or communicated from one computing device to another. Generally, the device data 1304 can include any form of audio, video, image, graphics, and/or electronic data that is generated by applications executing on a device. The communication devices 1302 can also include transceivers for cellular phone communication and/or for any type of network data communication.

The example device 1300 can also include various, different types of data input/output (I/O) interfaces 1306, such as data network interfaces that provide connection and/or communication links between the devices, data networks, and other devices. The data I/O interfaces 1306 may be used to couple the device to any type of components, peripherals, and/or accessory devices, such as a computer input device that may be integrated with the example device 1300. The I/O interfaces 1306 may also include data input ports via which any type of data, information, media content, communications, messages, and/or inputs may be received, such as user inputs to the device, as well as any type of audio, video, image, graphics, and/or electronic data received from any content and/or data source.

The example device 1300 includes a processor system 1308 of one or more processors (e.g., any of microprocessors, controllers, and the like) and/or a processor and memory system implemented as a system-on-chip (SoC) that processes computer-executable instructions. The processor system 1308 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1310. The example device 1300 may also include any type of a system bus or other data and command transfer system that couples the various components within the device. A system bus can include any one or combination of different bus structures and architectures, as well as control and data lines.

The example device 1300 also includes memory and/or memory devices 1312 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1312 include volatile memory and non-volatile memory, fixed and removable media devices, and any suitable memory device or electronic data storage that maintains data for computing device access. The memory devices 1312 can include various implementations of random-access memory (RAM), read-only memory (ROM), flash memory, and other types of storage media in various memory device configurations. The example device 1300 may also include a mass storage media device.

The memory devices 1312 (e.g., as computer-readable storage memory) provide data storage mechanisms, such as to store the device data 1304, other types of information and/or electronic data, and various device applications 1314 (e.g., software applications and/or modules). For example, an operating system 1316 may be maintained as software instructions with a memory device 1312 and executed by the processor system 1308 as a software application. The device applications 1314 may also include a device manager, such as any form of a control application, software application, signal-processing and control module, code that is specific to a particular device, a hardware abstraction layer for a particular device, and so on.

In this example, the device 1300 includes a context suitability manager 1318 that implements various aspects of the described features and techniques described herein. The context suitability manager 1318 may be implemented with hardware components and/or in software as one of the device applications 1314, such as when the example device 1300 is implemented as the mobile device 102 described with reference to FIGS. 1-12. An example of the context suitability manager 1318 is the context suitability manager 118 implemented by the mobile device 102, such as a software application and/or as hardware components in the mobile device. In implementations, the context suitability manager 1318 may include independent processing, memory, and logic components as a computing and/or electronic device integrated with the example device 1300.

The example device 1300 can also include a microphone 1320 and/or camera devices 1322, as well as motion sensors 1324, such as may be implemented as components of an inertial measurement unit (IMU). The motion sensors 1324 may be implemented with various sensors, such as a gyroscope, an accelerometer, and/or other types of motion sensors to sense motion of the device. The motion sensors 1324 can generate sensor data vectors having three-dimensional parameters (e.g., rotational vectors in x, y, and z-axis coordinates) indicating location, position, acceleration, rotational speed, and/or orientation of the device. The example device 1300 can also include one or more power sources 1326, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 1300 can also include an audio and/or video processing system 1328 that generates audio data for an audio system 1330 and/or generates display data for a display system 1332. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1300. Alternatively, the audio system and/or the display system are external, peripheral components to the example device.

Although implementations for personalized weather insight information and/or user preferences based on environmental context have been described in language specific to features and/or methods, the appended claims are not necessarily limited to the specific features or methods described. Rather, the specific features and methods are disclosed as example implementations for personalized weather insight information and/or user preferences based on environmental context, as well as other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a mobile device, including at least one processor coupled with a memory; and a context suitability manager implemented at least partially in hardware and configured to cause the mobile device to obtain media content related to a user; determine an environmental context based on the media content related to the user; and determine one or more user preferences associated with activity recommendations for the user given the environmental context derived from the media content related to the user.

Alternatively, or in addition to the above-described mobile device, any one or combination of: the media content related to the user includes at least one of a photo, a video, a calendar event, a recorded activity, or a social media post. The context suitability manager is configured to determine at least one of a location or an activity depicted in the media content related to the user, or a time of day associated with a depiction in the media content. The context suitability manager is configured to obtain weather data corresponding to the at least one of the location, the activity, or the time as determined from the media content. The one or more user preferences are based on user participation in an event indicated by the media content that is related to the user. The one or more user preferences are based on visual content depicted in the media content that is related to the user. The one or more user preferences are based on a setting of a device associated with the user. The one or more user preferences are based on text describing the media content that is related to the user.

In some aspects, the techniques described herein relate to a method, including obtaining media content related to a user and an indication of an activity; determining an environmental context based on the media content that indicates the user involved in the activity; and determining one or more user preferences associated with activity recommendations for the user related to the activity given the environmental context derived from the media content that is related to the user.

Alternatively, or in addition to the above-described method, any one or combination of: the media content related to the user includes at least one of a photo, a video, a calendar event, a recorded activity, or a social media post. The method further comprising determining at least one of a location, or an activity depicted in the media content related to the user, or a time of day associated with a depiction in the media content. The method further comprising obtaining weather data corresponding to the at least one of the location, the activity, or the time as determined from the media content. The one or more user preferences are based on user participation in an event indicated by the media content that is related to the user. The one or more user preferences are based on visual content depicted in the media content that is related to the user.

In some aspects, the techniques described herein relate to a system, including a memory to maintain one or more user preferences related to a weather condition; and a context suitability manager to obtain media content related to a user; determine an environmental context based on the media content related to the user; and determine the one or more user preferences associated with activity recommendations for the user given the environmental context derived from the media content related to the user.

Alternatively, or in addition to the above-described system, any one or combination of: the media content related to the user includes at least one of a photo, a video, a calendar event, a recorded activity, or a social media post. The context suitability manager is configured to: determine at least one of a location or an activity depicted in the media content related to the user; obtain weather data corresponding to at least one of the location, the activity, or a time as determined from the media content; and determine a weather condition as the environmental context associated with the weather data. The one or more user preferences are based on user participation in an event indicated by the media content that is related to the user. The one or more user preferences are based on visual content depicted in the media content that is related to the user. The one or more user preferences are based on text describing the media content that is related to the user.

1. A mobile device, comprising:
at least one processor coupled with a memory; and
a context suitability manager configured to cause the mobile device to:
obtain media content related to a user;
identify, using a machine learning model, an environmental context related to a weather condition depicted in the media content related to the user; and
identify, using the machine learning model, one or more user preferences associated with activity recommendations for the user given the environmental context derived from the media content related to the user.

2. The mobile device of claim 1, wherein the media content related to the user includes at least one of a photo, a video, a calendar event, a recorded activity, or a social media post.

3. The mobile device of claim 1, wherein the context suitability manager is configured to determine at least one of a location or an activity depicted in the media content related to the user, or a time of day associated with a depiction in the media content.

4. The mobile device of claim 3, wherein the context suitability manager is configured to obtain weather data corresponding to the at least one of the location, the activity, or the time as determined from the media content.

5. The mobile device of claim 1, wherein the one or more user preferences are based on user participation in an event indicated by the media content that is related to the user.

6. The mobile device of claim 1, wherein the one or more user preferences are based on visual content depicted in the media content that is related to the user.

7. The mobile device of claim 1, wherein the one or more user preferences are based on a setting of a device associated with the user.

8. The mobile device of claim 1, wherein the one or more user preferences are based on text describing the media content that is related to the user.

9. A method, comprising:
obtaining media content related to a user and an indication of an activity;
identifying, using a machine learning model, an environmental context related to a weather condition depicted in the media content that indicates the user involved in the activity; and
identifying, using the machine learning model, one or more user preferences associated with activity recommendations for the user related to the activity given the environmental context derived from the media content that is related to the user.

10. The method of claim 9, wherein the media content related to the user includes at least one of a photo, a video, a calendar event, a recorded activity, or a social media post.

11. The method of claim 9, further comprising determining at least one of a location, the activity depicted in the media content related to the user, or a time of day associated with a depiction in the media content.

12. The method of claim 11, further comprising obtaining weather data corresponding to the at least one of the location, the activity, or the time as determined from the media content.

13. The method of claim 9, wherein the one or more user preferences are based on user participation in an event indicated by the media content that is related to the user.

14. The method of claim 9, wherein the one or more user preferences are based on visual content depicted in the media content that is related to the user.

15. A system, comprising:
a memory to maintain one or more user preferences; and
a context suitability manager to:
obtain media content related to a user;
identify, using a machine learning model, an environmental context related to a weather condition depicted in the media content related to the user; and
identify, using the machine learning model, the one or more user preferences associated with activity recommendations for the user given the environmental context derived from the media content related to the user.

16. The system of claim 15, wherein the media content related to the user includes at least one of a photo, a video, a calendar event, a recorded activity, or a social media post.

17. The system of claim 15, wherein the context suitability manager is configured to:
determine at least one of a location or an activity depicted in the media content related to the user;
obtain weather data corresponding to at least one of the location, the activity, or a time as determined from the media content; and
determine the weather condition as the environmental context associated with the weather data.

18. The system of claim 15, wherein the one or more user preferences are based on user participation in an event indicated by the media content that is related to the user.

19. The system of claim 15, wherein the one or more user preferences are based on visual content depicted in the media content that is related to the user.

20. The system of claim 15, wherein the one or more user preferences are based on text describing the media content that is related to the user.
